(19) United States
(12) Patent Application Publication
(10) Pub. No.: US 2009/0187122 A1
(43) Pub. Date: Jul. 23, 2009

(54) Low Frequency Therapy Apparatus having a Function of Playing Music

(76) Inventor: Chin-Chih HSIEH, Yunghe City (TW)

Correspondence Address: HDLS Patent & Trademark Services, P.O. BOX 220746, CHANTILLY, VA, 20153-0746, US

(21) Appl. No.: 12/017,529

(22) Filed: Jan. 22, 2008

(51) Int. Cl. A61H 39/00

(52) U.S. Cl. 601/15

(57) ABSTRACT

A low frequency therapy apparatus having a function of playing music includes a shell. A display unit and a group of control key unit disposed on the shell. The control key unit is arranged underside of the display unit. A therapy mode and a music mode can be adjusted or switched by the control key unit, and the adjusted or switched result can be displayed by the display unit. A number of input/output ports and a memory card slot are defined on side surfaces of the shell. The input/output ports are configured for connecting with an electrode apparatus, a transformer, an earphone apparatus, and so on. The memory card slot is configured for connecting with a memory card which can store a music file, and an information of a user.

### BACKGROUND

This invention relates to low frequency therapy apparatuses, and particularly, to a low frequency therapy apparatus having a playing function.

Recently, with the improving of the life level of living, people take more and more care of their health. Acupuncture and massage are popularly used for relaxing tiredness of human body.

Acupuncture and massage can adjust an enginery of human body, build up resistance and even cure disease, by activating points of human body. However, these methods are professional technique, thus it can not be performed in family. To meet such requirement, a low frequency therapy apparatus which can relax muscles and adjust the enginery of human body using low electric current to activate points of human body.

The low frequency therapy apparatus can be performed in combination with a biofeedback therapy technique. The biofeedback therapy is a non-ablative treatment technique in which people are trained to improve their health using signals from their own bodies. Currently, the biofeedback therapy has been proved by a number of medical researches and clinical experiments. Therefore, the biofeedback therapy is a credible treatment method and will be wildly used in the future.

With respect to the therapy method of the biofeedback, a detector (e.g., an electromyographic apparatus) is disposed on a curer for acquiring electromyographic signals of the curer body. Then, the detector transmits the electromyographic signals to a therapy apparatus. An alert apparatus such as a display or a buzzer is electrically connected to the therapy apparatus. The therapy apparatus informs the curer with the alarm apparatus how to adjust the enginery of his body, according to the electromyographic signals. Specially, the alert apparatus transforms the electromyographic signals into alerting signals to inform the curer his body status. According to the alerting signals of the body status, the curer can adjust his body correspondingly. For example, when muscles of a curer become rigid due to his excessive tension, the alert apparatus can be started and produce an alerting signal. For example, the alert apparatus enables the light of the display to glitter, the buzzer to sound, the display to show letters corresponding to the muscles rigidity, or the like. In this instance, the curer tries to relax himself, unless the muscles have been relaxed, the alerting signal can be eliminated. When trained for a period of time using above-described method, the curer can observe the body status and adjust correspondingly himself even lack of the alert apparatus.

However, during the using of the low frequency therapy apparatus, an appropriate current is produced by the therapy apparatus and is transmitted into human body with an electrode apparatus to activate the points of human body. The nerve may be tired when the low frequency therapy apparatus has been used for a long time, thereby the muscles may be tensed correspondingly. Thus, a therapy efficiency of the low frequency therapy apparatus may be lowered. Furthermore, in application of the low frequency therapy apparatus, an electrode sheet of the electrode apparatus is pasted on the body of the curer, and a lead is provided to connect the therapy apparatus and the electrode sheet. In this instance, because the curer can not extend his body freely, after a long period of time, feelings of fastidium and anxiety may be produced. Thus, a desire for using the low frequency therapy apparatus may be rebated, and a therapy efficiency of the low frequency therapy apparatus may also be affected.

### BRIEF SUMMARY

A purpose of the present invention relates to a low frequency therapy apparatus having a function of playing music. The low frequency therapy apparatus not only has a therapy function, but also a function of playing music. When the low frequency therapy apparatus is used, the therapy process can be performed combining with playing music, thus the user can not feel humdrum, and a desire for using the therapy apparatus is also increased. In addition, due to the combination of the therapy function and playing music, a therapy effect can be evidently improved.

Another purpose of the present invention relates to a low frequency therapy apparatus having a function of playing music. A display unit and at least one group of control key unit are disposed on a shell of the therapy apparatus, thus a therapy mode and a music mode can be switched from each other, and the switched resulted can be displayed by the display unit. In addition, a frequency of the current output from the therapy apparatus can be adjusted by the control key unit, thus avoids human body is activated by the current with same frequency, thereby avoiding the tire of nerve of human body.

In order to achieve the above purposes, a preferable embodiment of the therapy apparatus is provided. The therapy apparatus a shell having a front surface. A display unit and at least a group of control key unit disposed on the front surface of the shell. The display unit is disposed on a top half portion of the front surface, and the control key unit is disposed on a bottom half portion of the front surface. A therapy mode and a music mode can be adjusted or switched by the control key unit, and the adjusted or switched result can be displayed by the display unit. A plurality of input/output ports and a memory card slot are defined on side surfaces of the shell. The input/output ports are configured for receiving or connecting with an electrode apparatus, a transformer, an earphone apparatus, and so on. The memory card slot is configured for receiving or connecting with a memory card which can store a music file, a health information of a user, and/or other appropriate information.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a three-dimensional view of a therapy apparatus of a preferable embodiment.

FIG. 2 shows a back of the therapy apparatus of FIG. 1.

FIG. 3 shows a connection of an electrode apparatus and the therapy apparatus of FIG. 1.

FIG. 4 shows a connection of a transformer and the therapy apparatus of FIG. 1.

FIG. 5 shows a connection of a memory card and the therapy apparatus of FIG. 1.

FIG. 6 shows a connection of an earphone apparatus and the therapy apparatus of FIG. 1.

### DETAILED DESCRIPTION

Embodiments will be described below and with reference to the drawings.

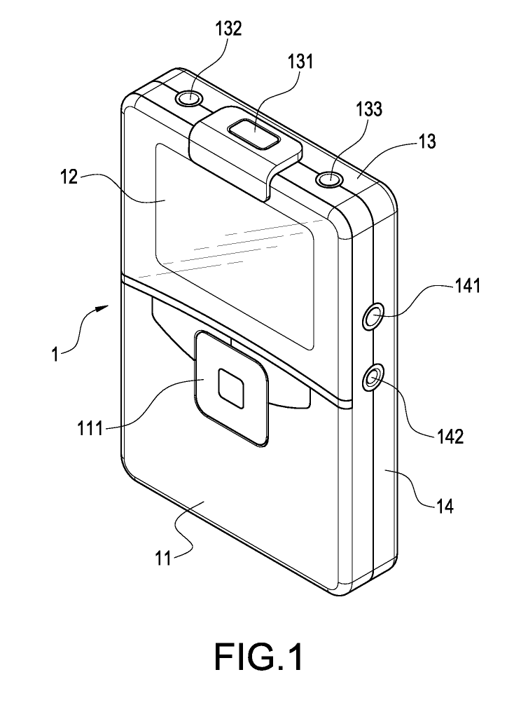

Referring to FIG. 1, a low frequency therapy apparatus in accordance with a preferable embodiment is shown. The therapy apparatus includes a rectangular shell 1. A display unit 12 is disposed on a top half portion of a front surface of the shell 1. The display unit 12 can be a liquid crystal display (LCD). A bottom half portion of the front surface of the shell 1 is a flat panel 11. At least a group of control key unit 111 is disposed on the panel 11. The control key unit 111 includes a therapy key, a music key, a number of current/music control keys, and an on/off key. The therapy key is configured for switching a mode of the therapy apparatus to a therapy mode. The music key is configured for switching a mode of the therapy apparatus to a music mode. The current/music control keys are configured for separately controlling an output of the current or a volume of the music. In detail, when the therapy apparatus is in the therapy mode, the current/music control key controls a current intensity of the current output from the therapy apparatus. When the therapy apparatus is in the music mode, the current/music control key selects the music to be played and controls a volume of the selected music. The on/off key is configured for controlling start or stop of the output of the current and/or the playing of the music.

The above-described state/mode which controlled/adjusted by the control key unit 111 can be displayed by the display unit 12. Keys in the control key unit 111 can be arranged according to a desired appearance of the therapy apparatus. For example, the keys in the control key unit 111 are arranged in a rectangular array, a circular pattern, an elliptical pattern and so on. It is to be understood that any potential variances in the arrangement of all of the keys in the control key unit 111 are considered to be within the scope of the present therapy apparatus. Furthermore, a selection of the keys in the control key unit 111 can be performed according to the corresponding state/mode which the therapy apparatus is in. A top surface 13 of the shell 1 defines two current output ports 132, 133. The two current output ports 132, 133 are configured for receiving or connecting with an external apparatus to output a current produced inside the therapy apparatus. An electrical source switch 131 is set between the two current output ports 132, 133 for controlling a state of on/off of the electrical source of the therapy apparatus. In addition, the two current output ports 132, 133 can be disposed on other side surface of the shell 1. For example, the two current output ports 132, 133 are disposed on a right side surface 14 or a left side surface 15 on opposite side of the right side surface 14. Furthermore, the electrical source switch 131 can be disposed on the surface of the panel 11. It is to be understood that any potential variances about the position of the two current output ports 132, 133 and the electrical source switch 131 are considered to be within the scope of the present therapy apparatus.

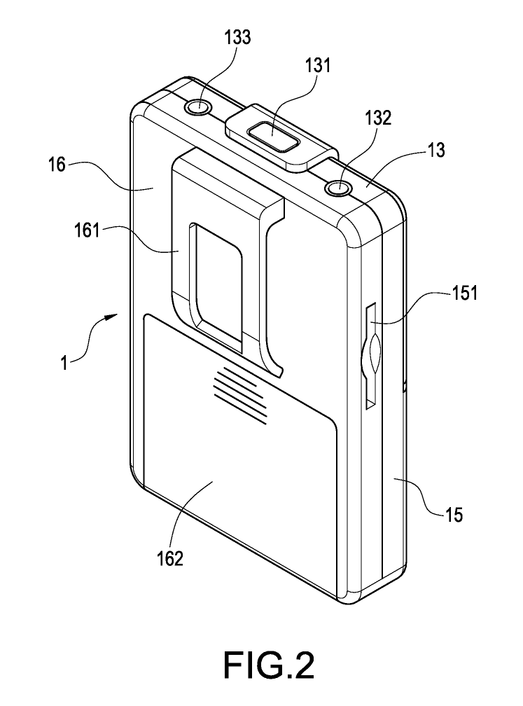

In the present embodiment, the right side surface 14 of the shell 1 defines an electrical source input port 141 for receiving or connecting with an external electrical source apparatus, and an earphone port 142 for receiving or connecting with an earphone apparatus. Referring to FIG. 2, the left side surface 15 of the shell 1 defines a memory card slot 151 for receiving or connecting with a memory card. According to their configurations or shapes, the electrical source input port 141, the earphone port 142 and the memory card slot 151 can be positioned on the top surface 13 of the shell 1 or a bottom surface (not labeled) of the shell 1 or any other appropriate part of the shell 1. A U-shaped hook 161 is disposed on a top half portion of a back surface 16 of the shell 1 from a top end to a bottom end thereof. The top end of the U-shaped hook 161 is close to the top surface 13, and is fixed on the back surface 16. A clearance is defined between the bottom end of the U-shaped hook 161 and the back surface 16 of the shell 1. Due to such clearance, the therapy apparatus can be hitched or hooked on a pocket, a waistband or other portions of human body by the U-shaped hook 161, thereby facilitating the portability of the therapy apparatus. A bottom half portion of the back surface 16 of the shell 1 defines a battery receiving groove (not shown) for containing a battery as an internal electrical source of the therapy apparatus. Due to the presence of the internal electrical source, the therapy apparatus can continue to work, even though not connecting with an external electrical source. The shell 1 additionally includes a cover 162 detachably installed on the back surface 16 for lidding/closing the battery receiving groove. After the internal electrical source is received/placed in the battery receiving groove, the cover 162 lids/closes the battery receiving groove to make sure the internal electrical source being fixed in the battery receiving groove.

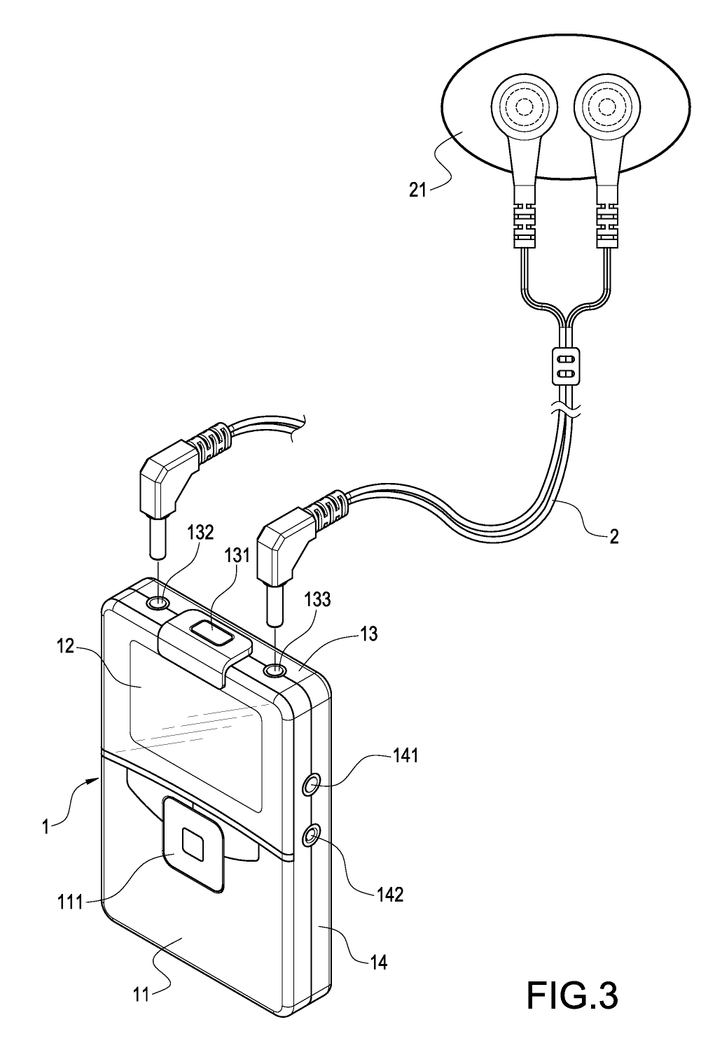

Referring to FIG. 3, each of the two current output ports 132, 133 can connect with an external electrode apparatus 2 to output the current produced from the therapy apparatus. The external electrode apparatus 2 includes an electrode sheet 21 configured for contacting with skin to activate/stimulate points of human body, thereby achieving a purpose of the therapy. Preferably, the electrode sheet 21 of the external electrode apparatus 2 can contact with different part of human body such as face, shoulder, arm, thigh, and so on, to activate/stimulate the points of the different part, thereby curing the different part of human body. During a process of curing different part of human body, the required current intensity for activating/stimulating the corresponding points of human body is different with each other. In this circumstance, the current/music control keys of the control key unit 111 can be used to adjust the current intensity of the current output from the external electrode apparatus 2, thereby the therapy apparatus achieving an optimal efficiency.

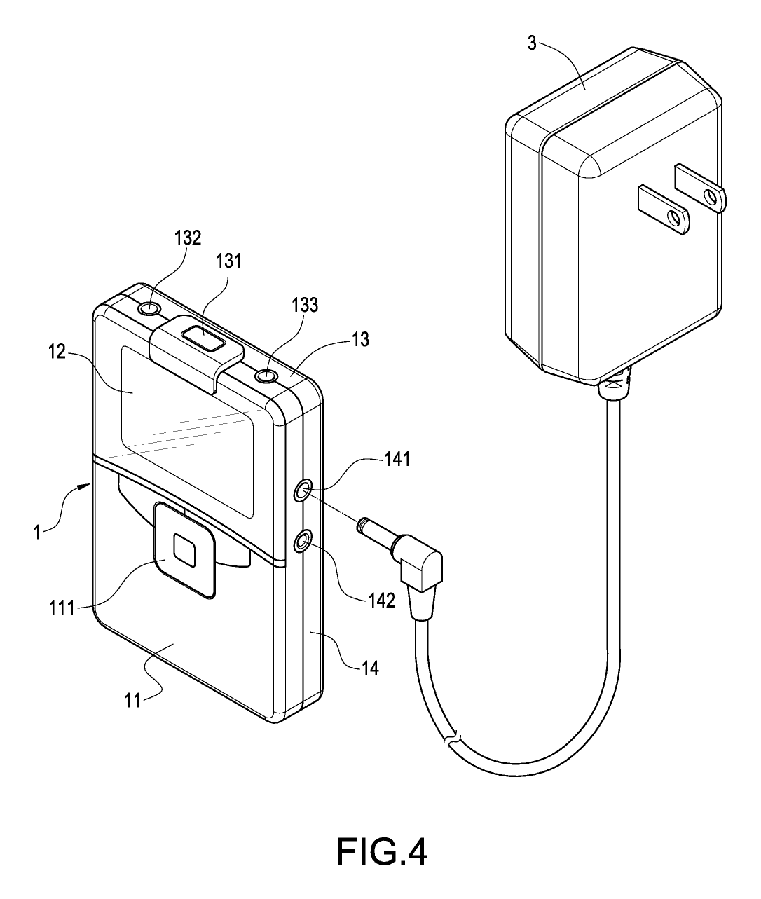

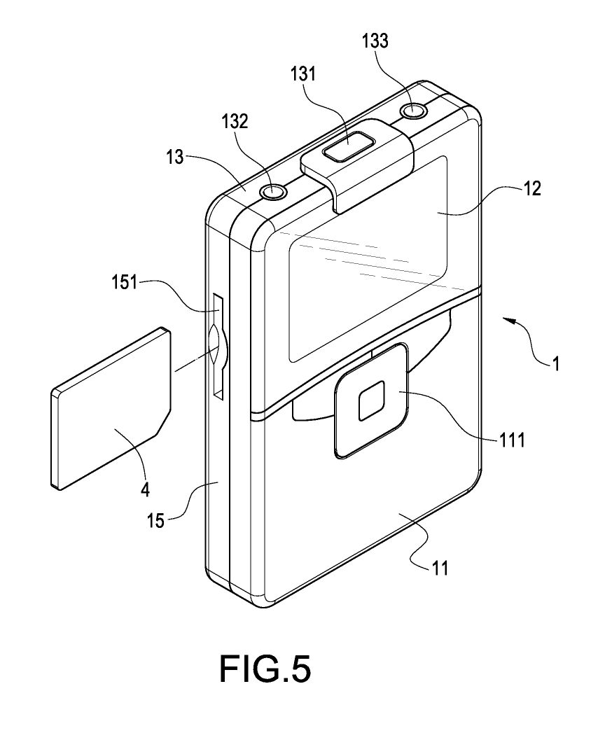

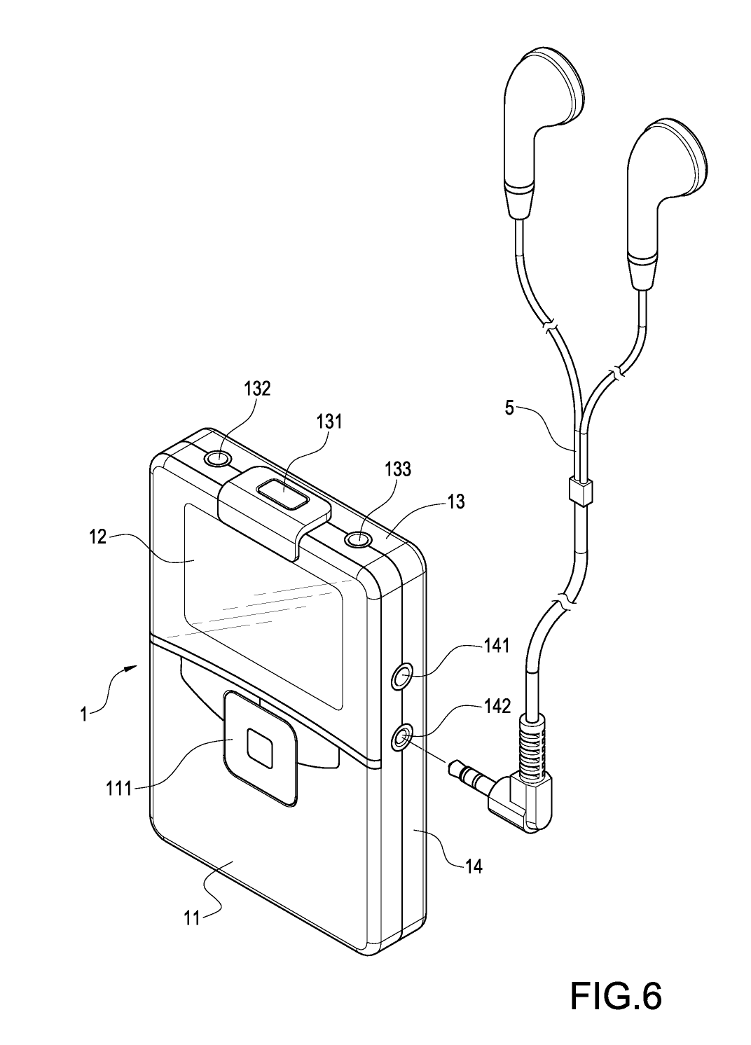

Referring to FIG. 4 to FIG. 6, the electrical source input port 141 connects to a transformer 3, and the earphone port 142 connects to an earphone apparatus 5. The earphone apparatus 5 can be a speaker or other appropriate apparatus. The memory card slot 151 of the left side surface 15 of the shell 1 receives or connects with an external memory card 4. In the present embodiment, the memory card 4 is Secure Digital (SD) memory card. It is to be understood that other potential memory cards with different function and capacity are considered to be within the scope of the present memory card 4.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A low frequency therapy apparatus having a function of playing music comprising:
a shell having a front surface;
a display unit and a control key unit disposed on the front surface of the shell; and
a plurality of input/output ports and a memory card slot defined on side surfaces of the shell.

2. The therapy apparatus claimed as claim 1, wherein the plurality of input/output ports comprise two current output ports configured for connecting with two electrode apparatuses to transmit a current produced by the therapy apparatus to electrode sheets of the two electrode apparatuses; an electrical source input port configured for connecting with an external electrical source apparatus; an earphone port configured for connecting with an earphone apparatus; and an electrical source switch configured for controlling a state of on/off of the therapy apparatus.

3. The therapy apparatus claimed as claim 2, wherein the shell comprises a top surface, and the two current output ports are positioned on the top surface.

4. The therapy apparatus claimed as claim 3, wherein the electrical source switch is disposed between the two current output ports.

5. The therapy apparatus claimed as claim 1, wherein the memory card slot is a slot for receiving a Secure Digital memory card.

6. The therapy apparatus claimed as claim 1, wherein the shell comprises a back surface on opposite side of the front surface, a battery receiving groove is defined in a bottom half portion of the back surface, and a cover detachably installed on the back surface for lidding/closing the battery receiving groove.

7. The therapy apparatus claimed as claim 1, wherein the display unit is a liquid crystal display.

8. The therapy apparatus claimed as claim 2, wherein the control key unit comprises a therapy key for switching a mode of the therapy apparatus to a therapy mode; a music key for switching a mode of the therapy apparatus to a music mode; a plurality of current/music control keys for separately controlling a current intensity of the current output from the current output port when the therapy apparatus in the therapy mode, and controlling a selection of the music and a volume of the selected music when the therapy apparatus in the music mode; and an on/off key for controlling start or stop of the output of the current and/or the playing of the music.

9. The therapy apparatus claimed as claim 8, wherein the control key unit additionally comprises an electrical source switch for controlling a state of on/off of an electrical source of the therapy apparatus.

10. The low frequency therapy apparatus claimed as claim 1, wherein a hook is disposed on a top half portion of the back surface of the shell for hitching/hooking the therapy apparatus.

11. A low frequency therapy apparatus having a function of playing music comprising:
a rectangular shell;
a display unit and at least one group of control key unit disposed on a front surface of the shell;
two opposite side surfaces of the shell define an electrical source input port, an earphone port and at least one memory card slot; and
a top surface of the shell defines two current output ports and an electrical source switch disposed between the two current out ports.
